(19) United States
(12) Patent Application Publication
(10) Pub. No.: US 2026/0040388 A1
(43) Pub. Date: Feb. 5, 2026

(54) Small Data Transmissions in a Wireless Network

(71) Applicant: Telefonaktiebolaget LM Ericsson (publ), Stockholm (SE)

(72) Inventors: Ali Parichehrehteroujeni, Linköping (SE); Andreas Höglund, Solna (SE); Mattias Bergström, Sollentuna (SE); Muhammad Ali Kazmi, Sundbyberg (SE); Tuomas Tirronen, Helsinki (FI); Marco Belleschi, Solna (SE); Pradeepa Ramachandra, Linköping (SE); Santhan Thangarasa, Vällingby (SE)

(21) Appl. No.: 18/997,682

(22) PCT Filed: Jul. 4, 2023
(86) PCT No.: PCT/SE2023/050697

§ 371 Date: Jan. 22, 2025

Related U.S. Application Data
(60) Provisional application No. 63/391,881, filed on Jul. 25, 2022.

(51) Int. Cl. H04W 76/27; H04W 74/0833

(52) U.S. Cl. CPC H04W 76/27; H04W 74/0833

(57) ABSTRACT

A method is performed by a user equipment. The method comprises logging information related to a small-data transmissions procedure performed by the user equipment in a report. The method further comprises transmitting the report to a network node.

### TECHNICAL FIELD

Embodiments of the present disclosure relate to methods, apparatus and computer-readable media relating to wireless networks, and particularly to small data transmissions in wireless networks.

### BACKGROUND

### Small Data Transmission

Small data solutions have earlier been introduced in Long-Term Evolution (LTE) with the focus on machine-type communication (MTC). For example, Rel-15 mobile originated (MO) Early Data Transmission (EDT) and Rel-16 mobile terminated (MT) EDT and Preconfigured Uplink Resources (PUR) have been standardized for LTE-M and narrowband Internet of Things (NB-IoT). Unlike these features, the Rel-17 Small Data Transmission (SDT) for New Radio (NR) is not directly targeting MTC use cases and the work item description (WID) includes smartphone background traffic as the justification. In Rel-17, SDT is covering MO traffic, i.e., uplink-initiated traffic, but work is starting up for MT-SDT, covering downlink-initiated traffic, in Rel-18.

The Rel-17 SDT WI objectives outline two main objectives: random access channel (RACH)-based schemes (also referred to as random access SDT, RA-SDT) and pre-configured physical uplink shared channel (PUSCH) resources (also referred to as configured-grant ST, CG-SDT). Comparing to LTE-M and NB-IoT, both 4-step RACH and 2-step RACH schemes are supported for SDT. The 4-step RACH-based scheme is similar to Rel-15 user plane (UP)-EDT and pre-configured PUSCH resources is similar to Rel-16 UP-PUR. Further, the Rel-17 SDT currently concerns only data transmission in INACTIVE state and hence CP-optimizations of EDT and PUR are so far not relevant. 2-step RACH has not been specified for LTE, and hence there is currently no LTE counterpart for 2-step RACH-based SDT.

### Random access procedure in 4-step RA type

The 4-step RACH scheme has been used in 4G LTE and is also the baseline for 5G NR. The principle of this procedure in NR is shown in FIG. 1.

### Step 1: Preamble Transmission

The UE randomly selects a RA preamble (PREAMBLE INDEX) corresponding to a selected synchronization signal (SS)/physical broadcast channel (PBCH) block of the comping/serving cell, transmit the preamble on the PRACH occasion mapped by the selected SS/PBCH block. When the gNB detects the preamble, it estimates the Timing advance (TA) the UE should use in order to obtain uplink (UL) synchronization at the gNB.

### Step 2: RA Response (RAR)

The gNB sends a RA response (RAR) including the TA, the TC-RNTI (temporary identifier) to be used by the UE, a Random Access Preamble identifier that matches the transmitted PREAMBLE_INDEX and an UL-grant for Msg3. The UE expects the RAR and thus, monitors physical downlink control channel (PDCCH) addressed to RA-RNTI to receive the RAR message from the gNB until the configured RAR window (ra-ResponseWindow) has expired or until the RAR has been successfully received.

From 3GPP TS38.321: “The MAC entity may stop ra-ResponseWindow (and hence monitoring for Random Access Response(s)) after successful reception of a Random Access Response containing Random Access Preamble identifiers that matches the transmitted PREAMBLE_INDEX.”

### Step 3: “Msg3” (UE ID or UE-Specific C-RNTI)

In Msg3 the UE transmits its identifier (UE ID, or more exactly the initial part of the 5G-TMSI) for initial access or if it is already in RRC_CONNECTED or RRC_INACTIVE mode and needs to e.g. re-synchronize, its UE-specific RNTI. If the gNB cannot decode Msg3 at the granted UL resources, it may send a downlink control information (DCI) addressed to TC-RNTI for retransmission of Msg3. Hybrid automatic repeat request (HARQ) retransmission is requested until the UEs restart the random access procedure from step 1 after reaching the maximum number of HARQ retransmissions or until Msg3 can be successfully received by the gNB.

### Step 4: “Msg4” (Contention Resolution)

In Msg4 the gNB responds by acknowledging the UE ID or C-RNTI. The Msg4 gives contention resolution, i.e. only one UE ID or C-RNTI will be sent even if several UEs have used the same preamble (and the same grant for Msg3 transmission) simultaneously.

For Msg4 reception, the UE monitors TC-RNTI (if it transmitted its UE ID in Msg3) or C-RNTI (if it transmitted its C-RNTI in Msg3).

### Random Access Procedure in 2-Step RA Type

The 2-step RA type gives much shorter latency than 4-step RA. In 2-step RA the preamble and a message corresponding to Msg3 (msgA PUSCH) in 4-step RA can, depending on configuration, be transmitted in two consecutive slots. The msgA PUSCH is sent on a resource dedicated to the specific preamble. This means that both the preamble and the Msg3 face contention but contention resolution in this case means that either both preamble and Msg 3 are sent without collision or both collide. The 2-step RA procedure is depicted in FIG. 2.

Upon successful reception msgA, the gNB will respond with a msgB. The msgB may be either a “successRAR”, “fallbackRAR or “Back off”. The content of msgB has been agreed (as seen in FIG. 2). It is noted in particular that fallbackRAR provides a grant for a Msg3 PUSCH that identifies resources in which the UE should transmit the PUSCH, as well as other information.

Note: The notations “msgA” and “MsgA” are used interchangeably herein to denote message A. Similarly, the notations “msgB” and “MsgB” are used interchangeably herein to denote message B.

The possibility of replacing the 4-step message exchange by a 2-step message exchange would lead to reduced RA latency. On the other hand, 2-step RA will consume more resources since it uses contention-based transmission of the data. This means that the resources that are configured for the data transmission may often be unused. Another difference is that 2-step RA operates without a timing advance (TA) since there is no feedback from gNB on how to adjust the uplink synchronization before the data payload is transmitted in MsgA PUSCH. Therefore, the UE applies TA=0 and the use of 2-step RACH is restricted to cells of smaller size.

If both 4-step and 2-step RA are configured in a cell on shared PRACH resources (and for the UE), the UE will choose its preamble from one specific set if it wants to do a 4-step RA, and from another set if it wants to do a 2-step RA. Hence a preamble partition is done to distinguish between 4-step and 2-step RA when shared PRACH resources are used. Alternatively, the PRACH configurations are different for the 2-step and 4-step RA procedures, in which case it can be deduced from where the preamble transmission is done if the UE is doing a 2-step or 4-step procedure.

In 3GPP Rel-16 2-step RA type procedure, UEs are informed of the potential time-frequency resources where they may transmit MsgA PRACH and MsgA PUSCH via higher layer signaling from the network. PRACH is transmitted in periodically recurring RACH occasions (‘ROs’), while PUSCH is transmitted in periodically recurring PUSCH occasions (‘POs’). PUSCH occasions are described in MsgA PUSCH configurations provided by higher layer signaling. Each MsgA PUSCH configuration defines a starting time of the PUSCH occasions which is measured from the start of a corresponding RACH occasion. Multiple PUSCH occasions may be multiplexed in time and frequency in a MsgA PUSCH configuration, where POs in an orthogonal frequency division multiplex (OFDM) symbol occupy a given number of physical resource blocks (PRBs) and are adjacent in frequency, and where POs occupy ‘L’ contiguous OFDM symbols. POs multiplexed in time in a MsgA PUSCH configuration may be separated by a configured gap ‘G’ symbols long. The start of the first occupied OFDM symbol in a PUSCH slot is indicated via a start and length indicator value (‘SLIV’). The MsgA PUSCH configuration may comprise multiple contiguous PUSCH slots, each slot containing the same number of POs. The start of the first PRB relative to the first PRB in a bandwidth part (BWP) is also given by the MsgA PUSCH configuration. Moreover, the modulation and coding scheme (MCS) for MsgA PUSCH is also given by the MsgA PUSCH configuration.

Each PRACH preamble maps to a PUSCH occasion and a demodulation reference signal (DMRS) port and/or a DMRS port-scrambling sequence combination according to a procedure given in 3GPP TS 38.213 v17.2.0. This mapping allows a gNB to uniquely determine the location of the associated PUSCH in time and frequency as well as the DMRS port and/or scrambling from the preamble selected by the UE.

### Small Data Transmission (SDT) Procedures

NR supports RRC_INACTIVE (in Release 17) state and UEs with infrequent (periodic and/or aperiodic) data transmission (interchangeably called small data transmission, or SDT) are generally maintained by the network not in RRC_IDLE but in the RRC_INACTIVE state. Up to Rel-16, the RRC_INACTIVE state doesn't support data transmission. Hence, the UE has to resume the connection (i.e. move to RRC_CONNECTED state) for any DL data reception and UL data transmission. Connection setup and subsequently release to RRC_INACTIVE state happens for each data transmission. This results in unnecessary power consumption and signaling overhead. For this reason, support for UE transmission in RRC_INACTIVE state using random access procedure is introduced in Rel-17, i.e. SDT. SDT is a procedure to transmit UL data from UE in RRC_INACTIVE state.

In FIG. 3, an example procedure is described. FIG. 3 provides a summary of a basic SDT procedure when a network decides to resume a UE after an SDT session.

SDT is performed with either random access (RA-SDT) or configured grant (CG-SDT). The case in which the UE transmits UL data with random access can use both 4-step RA and 2-step RA (see above). If the UE uses 4-step RA type for SDT procedure, then the UE transmits the UL data in the Msg3. If the UE uses 2-step RA type for SDT procedure, then the UE transmits UL data in the MsgA PUSCH.

Two types of Configured Grant (CG) UL transmission schemes have been supported in NR since Rel-15, referred to as CG Typel and CG Type2 in the standard. The major difference between these two types of CG transmission is that for CG Type1, an uplink grant is provided by radio resource control (RRC) configuration and activated automatically, while in the case of CG Type2, the uplink grant is provided and activated via LI signaling, i.e., by an UL DCI with cyclic reference check (CRC) scrambled by CS-RNTI. In both cases, the spatial relation used for PUSCH transmission with Configured Grant is indicated by the uplink grant, either provided by the RRC configuration or by an UL DCI.

The CG periodicity is RRC configured, and this is specified in the ConfiguredGrantConfig IE. Different periodicity values are supported in NR depending on the subcarrier spacing.

For use in SDT, only Configured Grant type 1 is supported and the gNB may configure the UE with Configured Grant and may also configure reference signal received power (RSRP) threshold(s) for selection of UL carrier. The configuration is given in the RRCRelease message sent to the UE while in connected state (to move the UE into Inactive state), or alternatively in another dedicated RRC message, for example while the UE is in RRC_CONNECTED. Alternatively, the configuration is given in RRCRelease message after a small data transmission procedure where the UE has started the procedure in RRC_INACTIVE and where the UE stays in RRC_INACTIVE after procedure completion. The use of Configured Grant type of resource requires the UE to remain synchronous state in that the time alignment is maintained. Should the UE be out of time alignment, a RA type of procedure can be initiated instead (see above).

Step 0: The UE in RRC_INACTIVE has a stored UE AS Inactive Context, including I-RNTI (received in the last RR (Release message including the suspendConfig) and the latest security keys (e.g. K_{RRCInt}, K_{RRCenc}, K_{UPInt}, K_{UPenc}) and while camping on a cell of Target gNB, determines to perform SDT (i.e. to start an SDT session).

Step 1: The UE Reestablishes and resumes SRB1 and other Radio Bearers (RBs) configured for SDT and derive a new KgNB for the target gNB based on the stored KgNB and the Next Hop Chaining Count (NCC) value stored (which has also been received in the last RR (Release message including suspendConfig).
a) This means, the UE will derive the K_{gNB} key for the target cell based on the current KgNB key or the NH, using the stored NCC value
b) UE will then compute the K_{RRCenc} key, the K_{RRCint} key, the K_{UPint} key and the K_{UPenc} key
c) Configures the PDCP layer for the SDT-RBs to apply the new keys derived above

Step 2: UE transmits an RRC Resume Request message including I-RNTI, resume MAC-I, Resume Cause+data over the SDT RBs.

Step 3: As in legacy resume procedure, the network performs context fetching with the last serving gNB, identified by the I-RNTI in Resume Request. The last serving gNodeB (which may be called an Anchor gNB) has the UE AS Inactive Context stored and based on the Resume MAC-I is able to identify that this is a legitimate UE, so the Anchor gNodeB provides the context to the Target gNodeB. This step is performed when the receiving gNB does not have the UE AS context.

Step 4: Upon receiving the UE AS Inactive Context, the Target gNodeB establishes the UE context and process the received SDT, and forward to the CN.

Step 5: Subsequent UL/DL data over SDT RBs may be exchanged, in case the UL data buffer is not emptied or more DL data than can be multiplexed with the RRORelease message.

Step 6: UE sends a non-SDT data indication in case of data arrival on DRB other than the SDT RB.

Step 7: The UE receives an RRCRelease including a suspendConfig, new NCC parameters (for key derivation in the next resume request) and a new I-RNTI, so the SDT session ends. Note that in case at Step 6 UE has non-SDT data the network may send RRCResume message to bring the UE to the RRC Connected state.

In step 6, if applicable, the UE triggers a transmission of a Dedicated Control Channel (DCCH) message to the network on SRB1 wherein a RRC message indicates the availability of data in the buffer of SRB(s)/DRB(s) not configured for SDT. The RRC message is transmitted as SDT data in the SDT procedure. Based on the RRC message, the NW may in step 7 bring the UE into CONNECTED mode with RRCResume response, or alternatively to IDLE mode using a RRCRelease including a suspendConfig.

### SDT Initiation

As shown in FIG. 4, which illustrates a flowchart of a method for initiating an SDT procedure, the UE needs to check some conditions and thresholds to decide whether to initiate the SDT or not. According to the RRC TS 38.331:

A UE in RRC_INACTIVE initiates the resume procedure for SDT when all of the following conditions are fulfilled:
1> the upper layers request resumption of RRC connection; and
1> SIBI includes sdt-ConfigCommon; and
sdt-Config is configured; and
1> all the pending data in UL is mapped to the radio bearers configured for SDT; and
1> lower layers indicate that conditions for initiating SDT as specified in TS 38.321 [3] are fulfilled.

The flowchart of the thresholds checked by the UEs during the SDT initiation procedure is shown in FIG. 4.

As shown, in the first step of the method, the UE verifies whether the data volume is less than the configured SDT data volume. In addition, the UE verifies whether the RSRP value is greater than the configured SDT RSRP threshold.

There currently exist certain challenge(s).

SDT operation for Inactive state UEs has been specified in Rel 17, see e.g. the RRC specification 3GPP TS 38.331 v17.0.0. However, the operation and its related configuration parameters cannot be optimized unless UE provides sufficient information concerning the executed SDT operation to the network.

One example scenario in which sub-optimal operation may occur is that a cell may broadcast a sub-optimal SDT supervision timer (e.g., T319a according to the RRC specification). This timer may be initiated or started upon the conditions for initiating SDT (e.g., as determined in FIG. 4) are fulfilled. While the timer is running, SDT transmissions may be performed; while the timer is not running, SDT transmissions may not be performed. A timer that is too short could lead to unsuccessful SDT operation e.g., abortion of SDT without complete transmission of all the SDT related data mapped to the SDT radio bearers. This increases RACH load as well as the latency of transmission, as the UE needs to initiate a further RACH procedure to complete the SDT operation.

Another example can be the situation that the network sets the SDT related RSRP threshold sub-optimally, such that the UEs in the cell are not able to perform SDT operation even though the RACH resources are partitioned by the RAN node for the UEs to perform SDT operation. This issue may have even more severe consequences, e.g., the threshold might have been set correctly by the RAN node but the coverage issue (e.g., uplink coverage issue or downlink uplink coverage disparity) at the cell does not allow the UE to perform SDT operations.

Another example may be where a UE has failed numerous times using 2-step RACH before later succeeding (using either 4-step or legacy RA), in which case it would be of interest for the gNB or the network more generally to find out more about these failed attempts.

### SUMMARY

Certain aspects of the disclosure and their embodiments may provide solutions to these or other challenges.

One aspect provides a method performed by a user equipment. The method comprises: logging information related to a small-data transmissions (SDT) procedure performed by the user equipment in a report; and transmitting the report to a network node.

A further aspect provides a method performed by a distributed unit (DU) of a base station. The method comprises: logging information related to a SDT procedure performed by a user equipment towards the DU in a report; and transmitting the report to a central unit (CU) of the base station.

A further aspect provides a method performed by a network node, The method comprises: receiving one or more reports comprising information relating to one or more SDT procedures, the one or more reports comprising one or more of: a first report received from a user equipment and comprising information relating to one or more SDT procedures performed by the user equipment; and a second report received from a distributed unit coupled to the network node and comprising information relating to one or more SDT procedures performed by the distributed unit. The method further comprises adapting one or more parameters for SDT procedures based on the information.

Certain embodiments may provide one or more of the following technical advantage(s).

The methods and solutions of the disclosure allow the wireless terminal (so-called UE) to log and report additional information concerning an SDT operation which assist the network to optimize the SDT operations related configurations. For example:
The network node knowing the data volume compared to the SDT data volume (e.g., how much the data volume was larger than configured threshold (sdt-DataVolume Threshold)) can optimize its SDT data volume threshold value steering UEs to perform SDT operation.
The network node knowing the RSRP value for some UEs who wanted to perform SDT operation was not above the SDT RSRP threshold (sdt-RSRP-Threshold) may take this information into account for the coverage optimization so the optimized coverage enables the UEs to perform more SDT operations if needed.
The network node knowing whether the UE was configured with the medium access control (MAC) and Physical (PHY) resources (sdt-MAC-PHY-CG-Config) when initiating the RA procedure may optimize the MAC and PHY resource allocations for the SDT operation i.e., if there are many UEs discarding their MAC and PHY SDT resources the gNB may avoid configuring such resources for the UEs.
The network node knowing the number of failed 2-step RA-SDT attempts before a successful attempt to be able to re-configure the number of 2-step RA-SDT preambles (i.e. change size of the PRACH partition) to reduce the collision rate.
The network node knowing the reason for RRC Resume failure while T319a timer was running. For example, the UE may indicate that the failure was due to “receiving Integrity check failure indication from lower layers while T319 or T319a”, or to the “maximum number of MCG RLC retransmissions has been reached while T319a is running, or to random access problem while T319a was running, or that cg-SDT-TimeAlignmentTimer expired while T319a was running, etc.
The network node knowing whether at the moment of initiating a random access procedure the UE had on the UL buffer data mapped to non-SDT bearers (in which case the UE may also indicate the specific non-SDT DRBs), or that while SDT RA procedure was ongoing (i.e. T319a timer was running) the UE received in the UL buffer non-SDT bearers (in which case the UE may also indicate the specific non-SDT DRBs) The network node knowing the more specific reasons for failing the RA-SDT or CG-SDT.
The network node knowing the reasons for failing the SDT during HD-FDD operation.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 is a signalling diagram showing a four-step random access procedure;

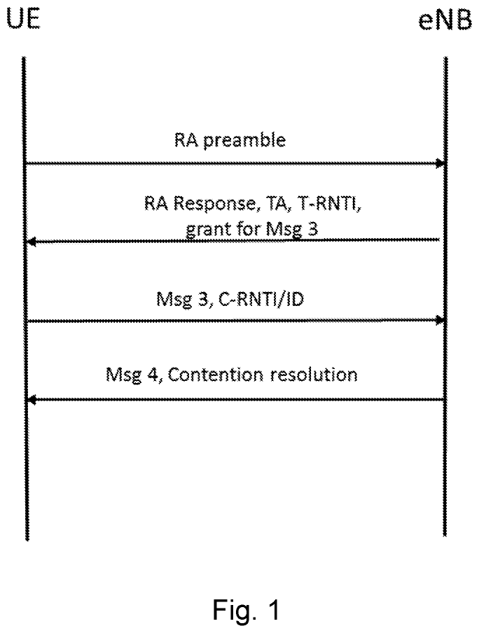

FIG. 2 is a signalling diagram showing a two-step random access procedure;

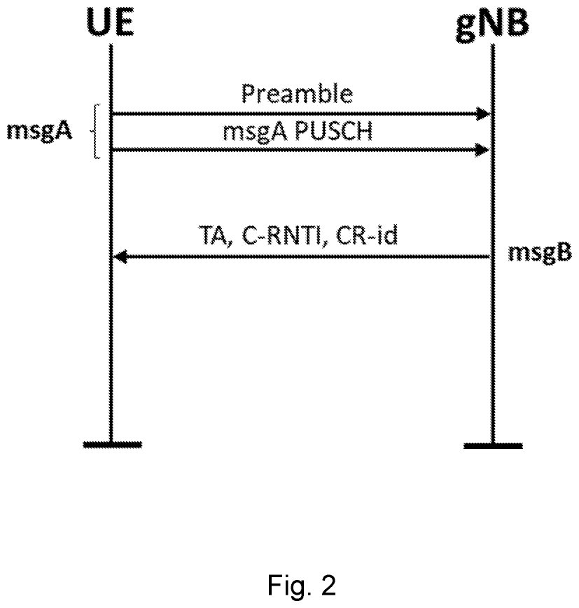

FIG. 3 is a signalling diagram showing a basic SDT procedure;

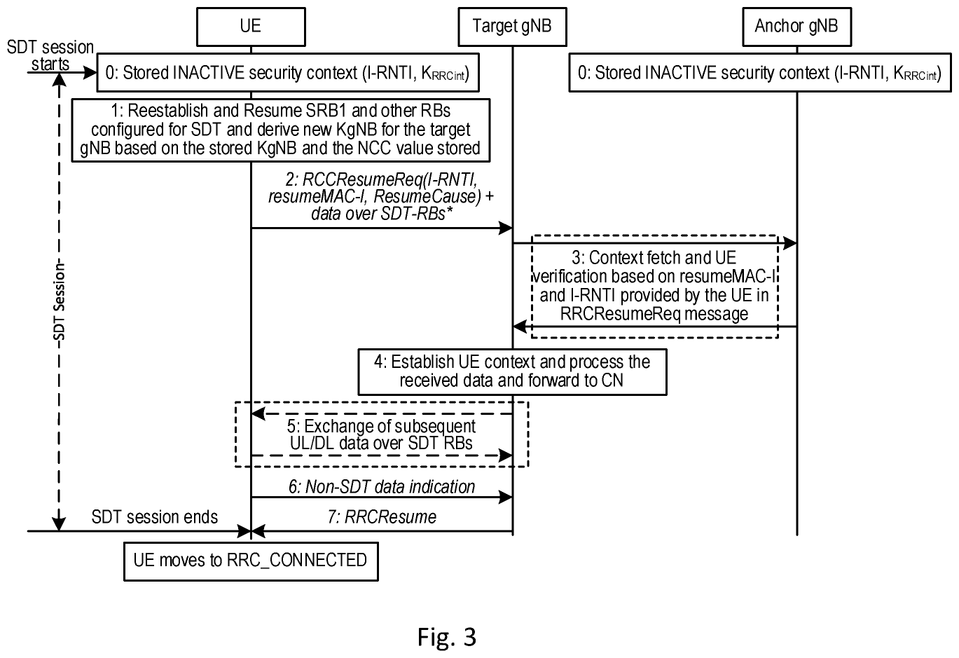

FIG. 4 is a flowchart illustrating a method for initiating SDT transmissions;

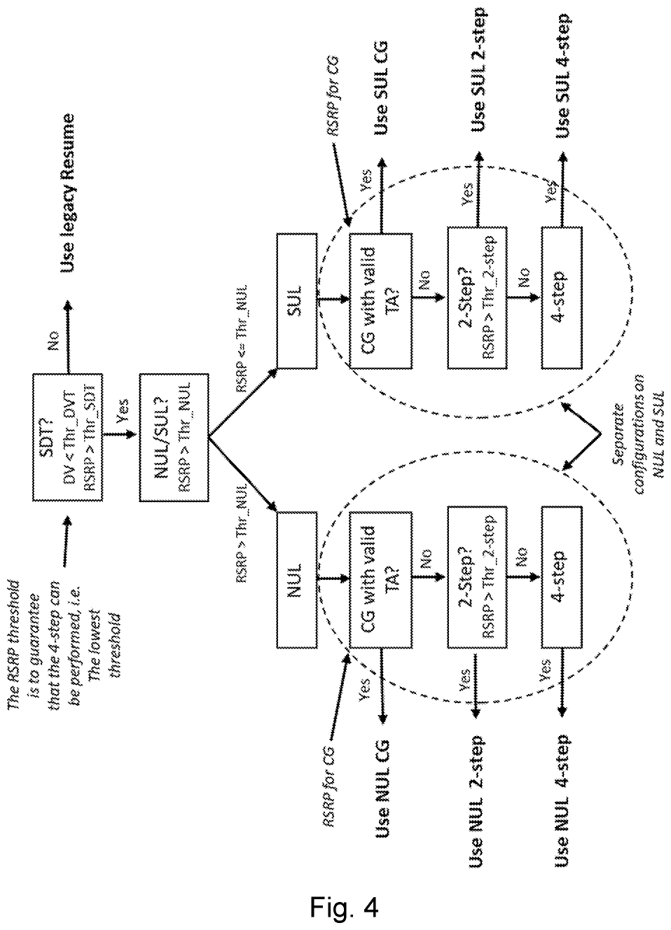

FIG. 5 is a signalling diagram showing communication between a UE and a network node according to embodiments of the disclosure;

FIG. 6 is a signalling diagram showing communication between a distributed unit of a base station and a central unit of the base station according to embodiments of the disclosure;

FIG. 7 is a signalling diagram showing communication between a UE, a distributed unit of a base station and a central unit of the base station according to embodiments of the disclosure;

FIG. 8 is a flowchart of a method performed by a UE;

FIG. 9 is a flowchart of a method performed by a distributed unit of a base station;

FIG. 10 is a flowchart of a method performed by a network node, such as a base station or a central unit of a base station;

FIG. 11 shows an example of a communication system in accordance with some

embodiments;

FIG. 12 shows a UE in accordance with some embodiments;

FIG. 13 shows a network node in accordance with some embodiments;

FIG. 14 is a block diagram of a host in accordance with various aspects described herein;

FIG. 15 is a block diagram illustrating a virtualization environment in which functions implemented by some embodiments may be virtualized; and

FIG. 16 shows a communication diagram of a host communicating via a network node with a UE over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

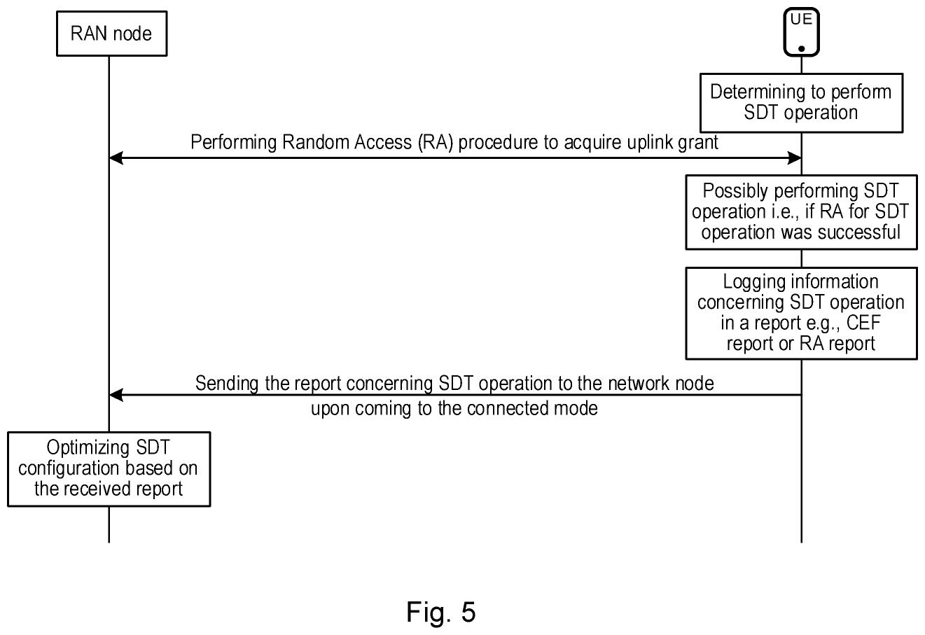

The solution proposed in this disclosure enables the UE to log and report information and measurements concerning a successful or failed Small Data Transmission (SDT) operation. One method disclosed in this document is performed by a wireless terminal—See FIG. 5, which illustrates building blocks of SON report signaling between a UE and a radio access network (RAN) node. The method comprises:
upon performing a random access-based or configured granted based procedure for the purpose of Small Data Transmission (RA-SDT, CG-SDT), either failed or successful operation:
the UE logs the information and measurements concerning the SDT operations in a report.
the UE transmit the report including the information and measurements concerning the SDT operation to the radio access network (RAN) node.

The network node, upon receiving the report (or a set of reports) including the information concerning the SDT operation, optimizes the SDT related configuration parameters.

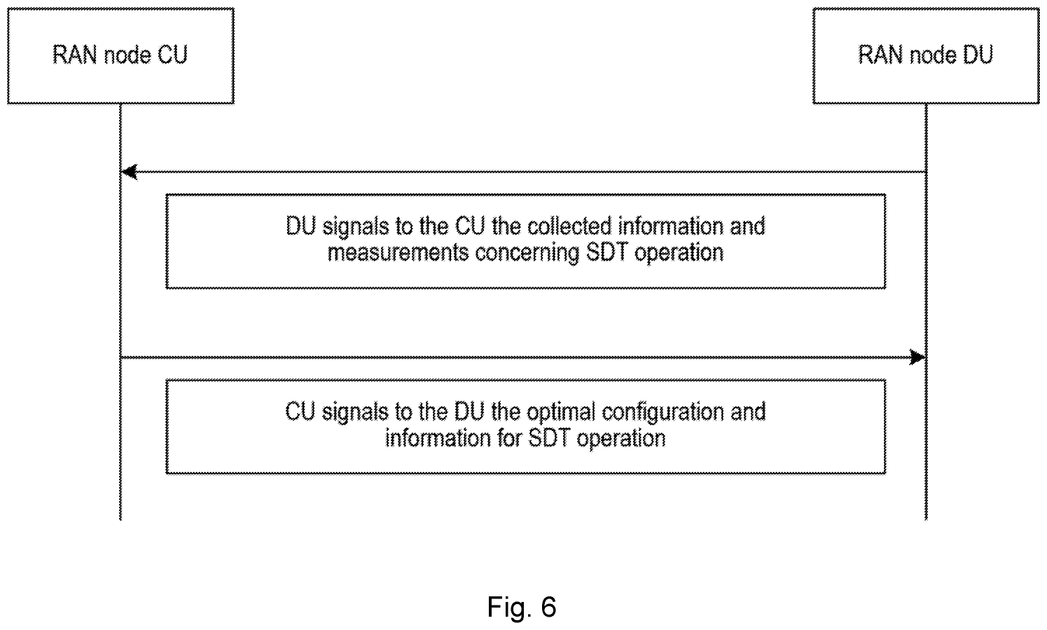

The method may also comprise signaling between RAN node elements in split RAN architecture between the DU and the CU. In this method, the DU provides information and measurements concerning SDT operation to the CU and the CU, in response to the provided information by the DU as well as UE reports, performs optimization and optionally sends the optimal configuration and information concerning SDT operation to the DU. See FIG. 6, which illustrates building blocks of SON report and configuration signaling between a CU and a DU for SDT operation.

The solution proposed in this document enables the UE to log and report information and measurements concerning a successful or failed Small Data Transmission (SDT) operation.

One method disclosed in this document is performed by a wireless terminal (so-called User Equipment).

Upon performing a random access (RA) procedure for the purpose of Small Data Transmission (SDT), e.g. at successful completion of the said RA or when declaring unsuccess of the said RA, the UE logs one or more of the following information in a report:
An indication indicating whether the data volume was above/below a preconfigured SDT data volume threshold (sdt-DataVolume Threshold). This information can be used by the RAN node to optimize the data volume threshold used for small data transmission. In an embodiment the data volume is a summation of the data volume at the packet data convergence protocol (PDCP) and radio link control (RLC) layer before initiating the RA procedure.
An indication indicating the absolute data volume before initiating the RA procedure.
An indication indicating the configured data volume threshold (e.g. sdt-DataVolume Threshold)
An indication indicating the extra data volume compared to the configured data volume threshold e.g., actual data volume value-(minus) sdt-DataVolume Threshold.
An indication indicating how much below the data volume threshold the data volume was e.g., sdt-DataVolume Threshold-data volume value.
An indication indicating whether the RSRP value before the initiation of the RA procedure (as part of SDT initiation) was above/below or below a preconfigured SDT RSRP threshold (sdt-RSRP-Threshold).
An indication indicating the measured RSRP upon initiating the RA procedure.
An indication indicating the configured RSRP threshold (e.g. sdt-RSRP-Threshold).
An indication indicating the difference between the measured RSRP and the configured RSRP threshold
An indication indicating whether a supervision timer (e.g., T319a SDT supervision timer) was expired at the middle of SDT operation i.e., before end of the SDT operation.
An indication indicating the time between the time arrival of the MO-Data in the UE's PDCP upper SAP to the time of the availability of the next CG-SDT for the transmission of the RRCResumeRequest message. This provides the information to the network regarding whether the density of the configured grants is sufficient or whether the UE had to wait for a long time before transmitting the actual data from the time of arrival in its PDCP upper SAP.
An indication indicating whether the UE was configured with the MAC and PHY resources (sdt-MAC-PHY-CG-Config) when initiating the RA procedure. In an embodiment, the indication indicates that the RA procedure was triggered as UE discarded the MAC and PHY resources configured for the SDT.
An indication indicating that the RA procedure is performed due to an SDT operation. In an embodiment the UE sets the ra-purpose to the SDT operation.
An indication indicating that the UE wanted to perform SDT operation but could not perform RA procedure for SDT operation as the SDT RSRP threshold was not met, so the UE performed legacy RRC Resume Request (or RRC Setup Request) procedures.
An indication of the number of failed SDT attempts before a successful attempt, either using 2-step RA-SDT, 4-step RA-SDT, or CG-SDT. Further information for the failed attempt could be appended and be any of e.g.: failure at preamble transmission, failure upon MsgA PUSCH transmission, failure upon Msg3 transmission, lost contention resolution, T319a expiration, failure due to cell change, etc.
   In a CG-SDT specific log could be the number of failed CG-SDT transmissions, and which CG-SDT occasions they occurred in (gNB cannot distinguish between a lost transmission in UL, and a transmission occasion not used by the UE).
   In a Rel-18 MT-SDT specific log, the UE could in addition indicate that the failure occurred during MT-SDT procedure.
An indication indicating that while performing RA for the purpose of Small Data Transmission (SDT), data associated to non-SDT data radio bearers (DRBs) were received, and possibly how much data were received. The UE may possibly also include an indication of the amount of non-SDT DRBs data available at the buffer, e.g. when terminating the RA procedure.
In case of failure of the said RA procedure, the UE may include the cause of such failure and an indication that when the failure occurred the T319a timer was running. For example, the UE may include indication that the RA procedure failed due to maximum performed RLC retransmissions while T319a timer was running, or that random access problems occurred while T319a timer was running, or that cg-SDT-TimeAlignmentTimer expired while T319a timer was running. In one embodiment, such information about a failed RA is included in the RLF-Report, in another embodiment in the RA-Report.

In another embodiment, upon performing a legacy RA procedure, i.e. non-SDT related the UE may include an indication indicating whether at the moment of initiating a RA procedure, SDT data were available in the buffer size, and possibly an indication indicating the amount of SDT data available for transmissions.

In one embodiment, upon finishing a SDT procedure, e.g. including the RA procedure and the possible subsequent transmission(s) after the initial SDT transmission using, the UE logs (any of) the following information in a report:
An indication indicating whether subsequent data transmission was used during the SDT procedure. For example, the UE may indicate whether subsequent configured grant CG SDT occasions were used, or how many remain unused when that no SDT data were left on the UL buffer.
An indication indicating the number of transmitted subsequent data packets or volume after the initial SDT transmission.
An indication indicting the total data volume transmitted during SDT procedure
   In one embodiment, the transmitted uplink and received downlink data for SDT are reported separately.
   In one embodiment, the data volume is a summation of the data volume calculated at the PDCP and RLC layer.
An indication indicating if CG-SDT were used.
An indication indicating the time interval between initiating the random access procedure related to SDT and the transmission of the initial SDT.
An indication indicating the time interval between the transmission of the Resume Request for the purpose of SDT, i.e. triggering T319a, and the first SDT transmission after transmitting the Resume Request.

In an embodiment the UE logs the SDR related measurement and information upon expiry of a supervision timer e.g., timer T319a, or upon reaching the maximum number of random access attempts even if the SDT supervision timer e.g., timer T319a is running.

In another embodiment, the UE is the configured (e.g. by the network node or based on one or more rules) to log and report information associated with a time alignment (TA) validation procedure performed by the UE for transmitting data using CG-SDT method. Examples of the information which the UE may log and report to the network comprise one or more of the following:
Signal measurement results (e.g. first RSRP measurement (RSRP1) value) obtained by the UE around a first time instance (T1) when the UE is configured or reconfigured with TA by the network node e.g. serving BS. The configured TA can be used for UE transmit timing adjustment for transmitting the data using e.g. CG-SDT mechanism.
Signal measurement results (e.g. second RSRP measurement (RSRP2) value) obtained by the UE around a second time instance (T2) when the UE validated the configured or reconfigured TA. In one example the TA is configured to be valid provided that the magnitude of the difference between RSRP1 and RSRP2 is below certain threshold. The UE may validate the TA before transmitting the data in the serving cell e.g. using CG-SDT mechanism.
Information indicating that the UE has been unable to transmit the data using SDT even though the UE intended to transmit the data e.g. data available in the buffer. The indication may further comprise information related to the type of SDT mechanism which was not successful to transmit the data e.g. CG-SDT. The information may further comprise the reason for unsuccessful transmission of the data using the SDT mechanism. For example, the reason of the failure (or unsuccessful attempt) may comprise one or more of the following: TA was invalid, RSRP1 was invalid, RSRP2 was invalid, time alignment timer (TAT) has expired, the CG-SDT occasion (e.g. resource where SDT can be transmitted) occurred after more than X1 time units after time instance, T2 etc. Examples of X1 time units are X2 ms, X3 time resources etc. Examples of time resources are symbols, slots, subframes, frames, SFN cycle, hyper SFN cycles etc. For example, RSRP1 is considered to be valid if it is measured within certain time range and around time instance T1; otherwise RSRP2 is considered to be invalid. In another example RSRP2 is considered to be valid if it is measured within certain time range and around time instance T2; otherwise RSRP2 is considered to be invalid.
Information indicating that the UE has been unable to perform one or more radio measurements if the SDT resources configured in the serving cell at least partially overlap in time with one or more measurement resources (MR) used for performing the measurements. The indication may further indicate the type of measurement which the UE was unable to perform due to at least partial overlap of the SDT resources with the MR in time. Examples of measurement resources are reference signals (RS) or RS occasions (RSO) used for measurements etc. A RSO which may comprise a time occasion or time window may contain one or more RSs. Examples of RS used for measurements are synchronization signal block (SSB), channel state information RS (CSI-RS), positioning reference signal (PRS) etc. Examples of RSO are SS/PBCH measurement timing configuration (SMTC) occasion or SMTC duration or SMTC window, PRS resource, PRS resource set etc. Examples of measurements are RSRP, reference signal received quality (RSRQ), signal to interference and noise ratio (SINR), measurements for propagation delay compensation (PDC) (e.g. UE Rx-Tx time difference etc), positioning measurements (e.g. PRS-RSRP, PRS reference signal received path power (PRS-RSRPP), reference signal time difference (RSTD), UE Rx-Tx time difference etc) etc. The measurement may be performed by the UE on one or more cells e.g. serving cell, neighbor cell, reference cell (e.g. used in positioning measurement, RSTD) etc. The cells on which the measurement is performed may belong to the serving carrier frequency (e.g. intra-frequency carrier), non-serving (e.g. inter-frequency carrier, inter-radio access technology (RAT) carrier frequency such as LTE carrier frequency etc), positioning frequency layer etc. In one example the UE may not be able to perform the measurement if at least one measurement resource (MR) overlaps with SDT resources allocated or configured for subsequent SDT transmissions in the serving cell. The subsequent SDT transmissions occur after the first or initial SDT transmission. In one specific example the indication may comprise information that the UE was unable to perform inter-frequency measurement on one or more cells on certain carrier frequency (e.g. F2) because at least one subsequent SDT transmission at least partially overlapped in time with at least one SMTC occasion on F2. The frequency information may be logged in terms of frequency channel number e.g. absolute radio frequency channel number (ARFCN), NR ARFCN (NR-ARFCN), EUTRA ARFCN (EARFCN) etc. In another specific example the indication may comprise information that the UE delayed the reception of PRS resources until the SDT session was completed because the measurement using PRS resource (e.g. for PDC, for positioning etc) overlapped with the SDT resources.

In any of the above example of logging and reporting, the UE may further log information about the UE geographical location (e.g. UE geographical coordinates) using one or more positioning methods (e.g. global navigational satellite system (GNSS), enhanced cell ID, observed time difference of arrival (OTDOA) etc). The UE may further log timing information (e.g. time stamp, UTC time, relative time wrt reference time etc) when the UE logs any of the above information. In yet another embodiment, the UE is the configured (e.g. by the network node or based on one or more rules) to log and report information associated with UE synchronization procedure performed by the UE for transmitting data using CG-SDT method. Examples of the information which the UE may log and report to the network comprise one or more of the following:
Whether the UE has failed one or more CG-SDT transmissions due to that UE failed to synchronize towards the serving cell. In this case, the logging information may further contain the N_{TA} values were used, the number times the synchronization procedure failed, whether the intended transmission was dropped or postponed, whether UE carried out the transmission using any fallback procedure such as RA-SDT.

In yet another embodiment related to half-duplex (HD) operation, the UE is the configured (e.g. by the network node or based on one or more rules) to log and report information related to procedures associated with CG-SDT and RA-SDT as described below:
In one example, the UE logs and reports to the network information related to prioritization between uplink and downlink due to HD-frequency division duplex (HD-FDD) operation. More specifically, since the HD-FDD UE cannot perform simultaneous reception and transmission, the logged information comprises whether one or more SDT transmissions (e.g. CG-SDT or RA-SDT) were dropped, postponed or suspended due to SDT transmissions overlapping with paging reception. Since SDT-transmissions have lower priority than paging reception, by reporting this information the network (NW) knows the reason for the failure and that its current SDT configuration (such as RSRP threshold, data threshold) may still be valid.
In another example, the logs and reports to the network information related to RA-SDT. The said information comprises the reason for failing with RA-SDT transmissions which could be that the UE failed to receive at least one SSB associated with that PRACH resource during the last Tp period in the cell due to HD-FDD operation, where e.g. Tp=160 ms

In another embodiment, the UE includes the identifier of the SDT DRBs in which the UE received the data that resulted in performing SDT. Based on this the network would get to know which SDT DRB is more prone to perform more frequent SDT. This would aid the network in determining the relevant configuration of the SDT resources.

### Signaling of the Report from the UE to the Network

In an embodiment the UE logs the information and measurements concerning the SDT operation in a connection establishment failure (CEF) report, and sends it as part of connection establishment failure report list to the network.
In a sub-embodiment the information and measurement concerning an SDT operation is logged in the CEF report only upon failure of the SDT operation

In an embodiment the UE logs the information and measurements concerning the

SDT operation in a random access (RA) report, and sends it as part of a list of RA reports to the network.
In a sub-embodiment the information and measurement concerning an SDT operation is logged in the RA report only upon successful SDT operation.

In an embodiment the UE logs the information and measurements concerning the SDT operation in a dedicated report designed for SDT operation, and sends it to the network.
In a sub-embodiment the information and measurement concerning an SDT operation is logged in the dedicated new report only upon successful SDT operation
In a sub-embodiment the information and measurement concerning an SDT operation is logged in the dedicated new report only upon failed SDT operation.
In a sub-embodiment the information and measurement concerning an SDT operation is logged in the dedicated new report upon successful or failed SDT operation

### Network Embodiments

### Collection and Reporting SDT Related Information and Measurements from DU to the CU

In an embodiment of this disclosure, the Distributed Unit (DU) of a cell in which camped UEs are allowed to perform SDT operations sends information and measurements concerning SDT operation to the Central Unit (CU) where the SDT configuration parameters can be optimized.

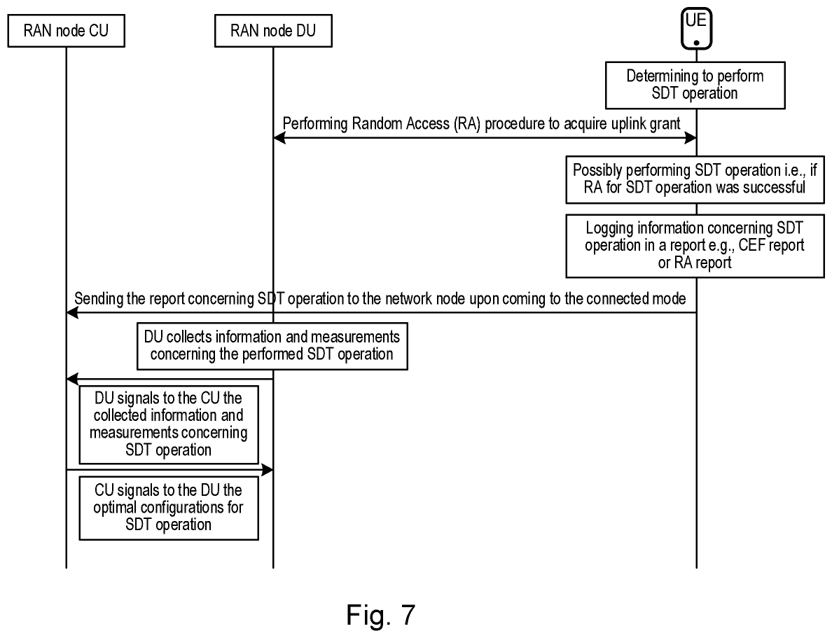

FIG. 7 illustrates the collection of information and measurements concerning a (set of) SDT operation performed by a (set of UEs) from DU to the CU.

A further method disclosed in this document is performed by a distributed unit (DU) of a base station.

Upon receiving a random access preamble dedicated to the SDT, corresponding to performing an SDT operation by a UE camped in a cell served by a DU, the DU starts collecting measurements and information concerning the SDT operation performed by the UE.

The method comprises logging one or more of the following information and measurements:
The buffer level reported by the UE for the SDT operation. The power headroom reported by the UE for SDT operation
The modulation and coding scheme used for SDT operation.
The HARQ retransmission performance including the number or the ratio of retransmission for the SDT operation.
Whether the UE had more SDT data when the RAN node sends RRC Release or RRC Resume message to the UE changing the UE RRC connection state.

The method comprises collecting the information and measurements concerning the SDT operation in a report/signal to be sent to the CU.
In an embodiment the SDT related information and measurements are sent from DU to the CU as part of a UE associated signal including the UE identities.
In another embodiment the SDT related information and measurements are sent from CU to the DU as part of a non-UE associated signal.
In yet another embodiment the information and measurements concerning SDT operation is sent either as a single or a plurality of the report (e.g., as a list of SDT related reports) to the CU.

A further method comprises signaling from the CU to the DU including the assistance information and configuration for SDT operation.

In an embodiment the CU sends to the DU the configuration parameters to be used for SDT operations.

In another embodiment the CU sends to the DU whether to configure the MAC and PHY resources for the SDT operation or not.

In yet another embodiment the CU sends to the DU an indication indicating the type of the allowed SDT operation, either only RA based SDT, or preconfigured grant based SDT or both of them.

In yet another embodiment the CU sends to the DU an indication indicating the UEs types (e.g., UE class) allowed to be configured with preconfigured grants.

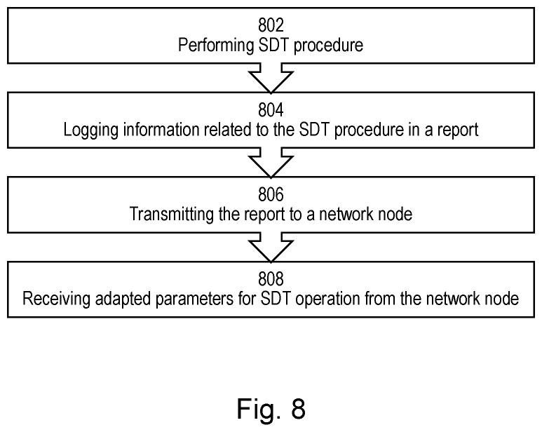

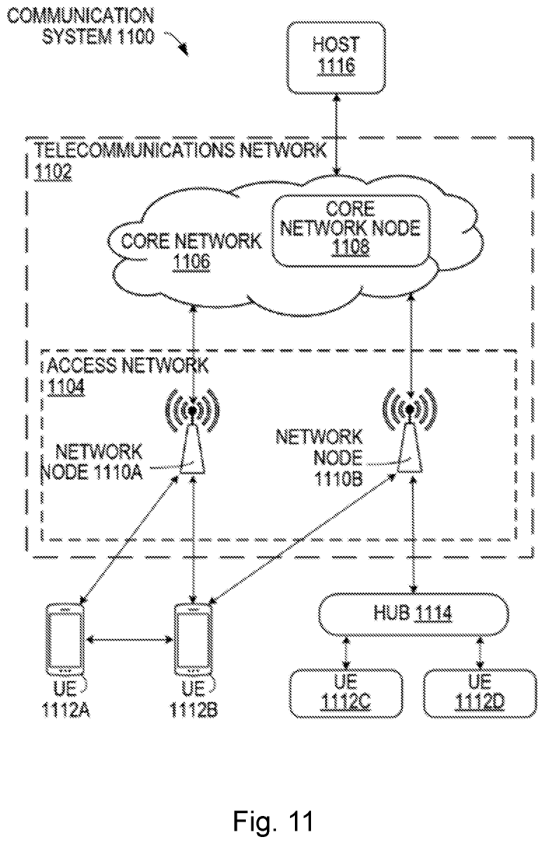

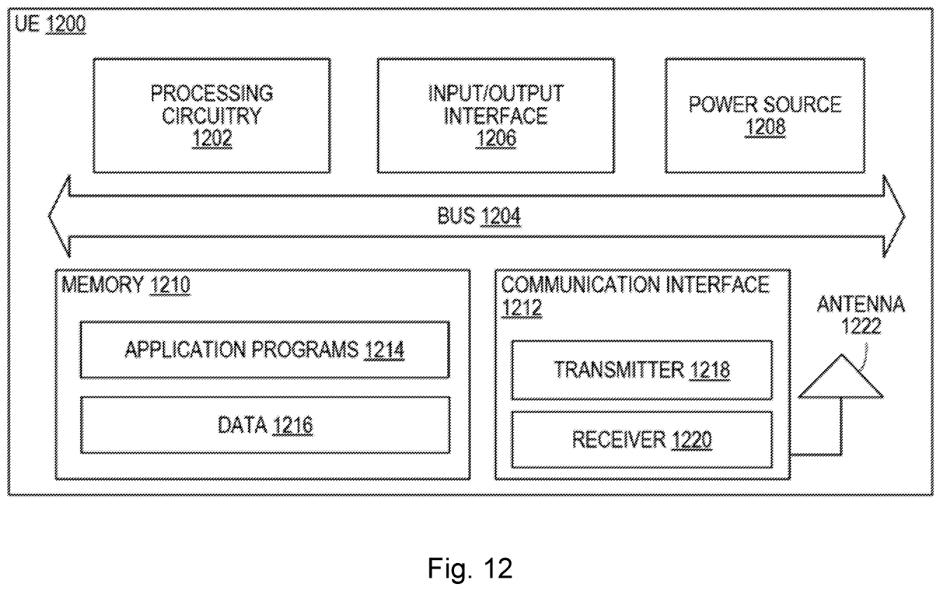

FIG. 8 depicts a method in accordance with particular embodiments. The method 8 may be performed by a UE or wireless device (e.g. the UE 1112 or UE 1200 as described later with reference to FIGS. 11 and 12 respectively).

The method begins at step 802, in which the UE performs an SDT procedure. Note this procedure may be successful (e.g., data or all data available for transmission by the UE to a network node is transmitted successfully) or unsuccessful (e.g., some or all data available for transmission by the UE to the network node is not transmitted). The SDT procedure may comprise an uplink transmission of an amount of data less than a threshold while in an inactive state (e.g., RRC_Inactive). The uplink transmission may use a configured grant of resources (e.g., CG-SDT) or follow a random-access procedure (e.g., RA-SDT).

In step 804, the UE logs information related to the SDT procedure in a report. For example, the information may be logged responsive to failure of the SDT procedure, or logged responsive to success of the SDT procedure. The report may comprise one of: a random-access report; and a connection establishment failure report. The information related to the SDT procedure may comprise information related to a failed SDT procedure (e.g., where the procedure in step 802 fails) or a successful SDT procedure (e.g., where the procedure in step 802 succeeds).

In step 806, the UE transmits the report to a network node. Again, the report may be transmitted responsive to failure of the SDT procedure, or responsive to success of the SDT procedure. The report may comprise information related to a plurality of SDT procedures performed by the user equipment. Alternatively, the report may be transmitted to the network node as part of a set of a plurality of reports comprising information related to SDT procedures performed by the user equipment.

In step 808, the UE receives, from the network node, one or more parameters for performing SDT procedures (i.e., further SDT procedures). The parameters are updated based on the information in the report logged in step 804 and transmitted in step 806.

Various embodiments concerning the information related to SDT procedure(s) logged and reported by the UE are set out above. For example, the information related to the SDT procedure may comprise information relating to an amount of data intended for transmission in the SDT procedure performed by the user equipment. Such information may comprise, for example, one or more of: an indication of the amount of data stored in one or more buffers in the user equipment for transmission; an indication of a threshold applied by the user equipment to the amount of data to determine whether uplink transmission using the SDT procedure is permitted; and an indication of a difference between the amount of data stored in one or more buffers in the user equipment for transmission and the threshold applied to the amount of data.

The information related to the SDT procedure may alternatively or additionally comprise information relating to a radio environment experienced during the SDT procedure performed by the user equipment. Such information may comprise, for example, one or more of: an indication of a received signal power upon initiating or during the SDT procedure; an indication of a threshold applied by the user equipment to the received signal power to determine whether uplink transmission using the SDT procedure is permitted; an indication of a difference between the received signal power and the threshold applied to the received signal power; and an indication of whether the received signal power was greater than or less than the threshold.

The information related to the SDT procedure may alternatively or additionally comprise information relating to a timing of transmissions during the SDT procedure performed by the user equipment. Such information may comprise, for example, one or more of: an indication of whether a supervision timer expired during the SDT procedure; an indication of a time between arrival of data in one or more buffers for transmission by the user equipment during the SDT procedure and a configured grant of resources for the SDT procedure.

The information related to the SDT procedure may alternatively or additionally comprise information relating to a random-access procedure performed during the SDT procedure performed by the user equipment. Such information may comprise, for example, one or more of: an indication of whether the user equipment was configured with MAC or PHY resources when initiating the random-access procedure; an indication of whether the random-access procedure was triggered upon the user equipment discarding MAC or PHY resources; an indication of a purpose of the random-access procedure; an indication of a number of failed random-access attempts by the user equipment; an indication of whether the random-access procedure was a two-step procedure or a four-step procedure.

The information relating to the SDT procedure may alternatively or additionally comprise information relating to an amount of data transmitted during the SDT procedure. Such information may comprise, for example, one or more of: an indication of the amount of data transmitted during the SDT procedure; an indication of an amount of data remaining to be transmitted at the conclusion of the SDT procedure; and an indication of an amount of data transmitted after an initial transmission during the SDT procedure.

The information relating to the SDT procedure may alternatively or additionally comprise information relating to a geographical location of the user equipment during the SDT procedure.

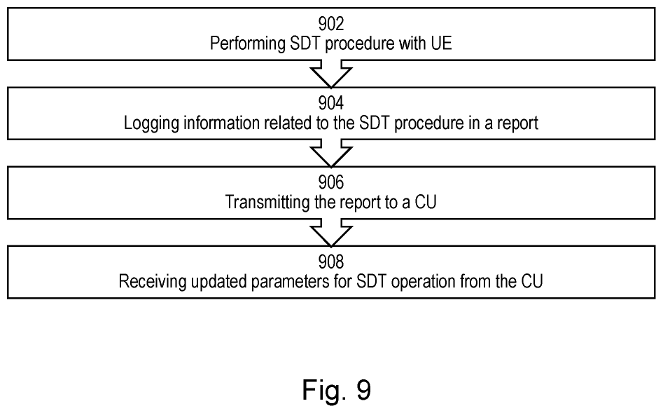

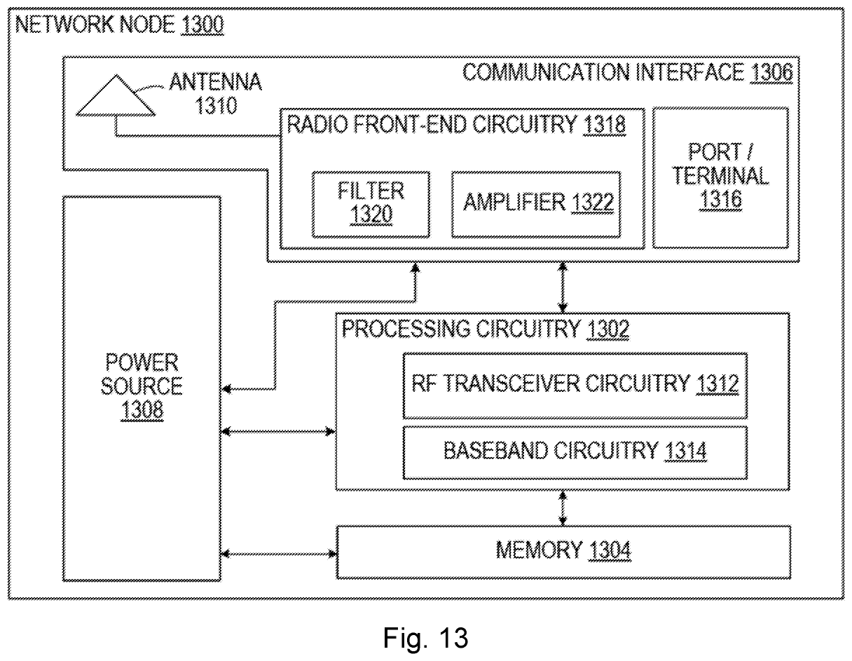

FIG. 9 depicts a method in accordance with particular embodiments. The method 9 may be performed by a network node (e.g. the network node 1110 or network node 1300 as described later with reference to FIGS. 11 and 13 respectively). In particular embodiments, the method may be performed by a distributed unit (DU) of a base station having split architecture.

The method begins at step 902, in which the DU performs an SDT procedure with a UE. Note this procedure may be successful (e.g., data or all data available for transmission by the UE to the DU is transmitted successfully) or unsuccessful (e.g., some or all data available for transmission by the UE to the DU is not transmitted). The SDT procedure may comprise an uplink transmission of an amount of data less than a threshold while in an inactive state (e.g., RRC_Inactive). The uplink transmission may use a configured grant of resources (e.g., CG-SDT) or follow a random-access procedure (e.g., RA-SDT).

In step 904, the DU logs information related to the SDT procedure in a report. The information related to the SDT procedure may be logged responsive to commencement of the SDT procedure by the user equipment, e.g., responsive to reception of a random-access preamble configured for SDT procedures from the user equipment.

Various embodiments concerning the information related to SDT procedure(s) logged and reported by the DU are set out above. For example, the information related to the SDT procedure may comprise one or more of: an indication of a power headroom reported by the user equipment for the SDT procedure; an indication of a buffer level reported by the user equipment for the SDT procedure; an indication of a modulation and coding scheme used by the user equipment for the SDT procedure; an indication of a HARQ performance of the user equipment for the SDT procedure; and an indication of whether the user equipment had more SDT data for transmission to the base station upon the base station transmitting a message to the user equipment to change its connection state.

In step 906, the DU transmits the report to a CU of the base station. The report may comprise information related to a plurality of SDT procedures performed by one or more user equipments, or be transmitted to the CU as part of a set of a plurality of reports comprising information related to SDT procedures performed by one or more user equipments.

In step 908, the DU receives, from the CU, one or more parameters for performing SDT procedures (i.e., further SDT procedures). The parameters are updated based on the information in the report logged in step 904 and transmitted in step 906.

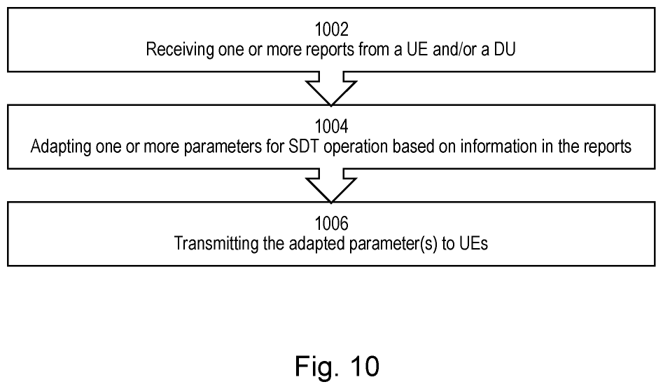

FIG. 10 depicts a method in accordance with particular embodiments. The method 10 may be performed by a network node (e.g. the network node 1110 or network node 1300 as described later with reference to FIGS. 11 and 13 respectively). In particular embodiments, the method may be performed by a central unit (CU) of a base station having split architecture. Alternatively, the method may be performed by a base station (e.g., which may not have split architecture).

The method begins at step 1002, in which the CU receives one or more reports comprising information relating to one or more small data transmission, SDT, procedures. The one or more reports comprise one or more of: a first report received from a user equipment and comprising information relating to one or more SDT procedures performed by the user equipment; and a second report received from a distributed unit coupled to the network node and comprising information relating to one or more SDT procedures performed by the DU. Note the SDT procedure(s) may be successful (e.g., data or all data available for transmission by the UE to a network node is transmitted successfully) or unsuccessful (e.g., some or all data available for transmission by the UE to the network node is not transmitted). The SDT procedure may comprise an uplink transmission of an amount of data less than a threshold while in an inactive state (e.g., RRC_Inactive). The uplink transmission may use a configured grant of resources (e.g., CG-SDT) or follow a random-access procedure (e.g., RA-SDT).

Various embodiments concerning the information related to SDT procedure(s) logged and reported by the UE and the DU are set out above. For example, the information related to the SDT procedure may comprise information relating to an amount of data intended for transmission in the SDT procedure performed by the user equipment. Such information may comprise, for example, one or more of: an indication of the amount of data stored in one or more buffers in the user equipment for transmission; an indication of a threshold applied by the user equipment to the amount of data to determine whether uplink transmission using the SDT procedure is permitted; and an indication of a difference between the amount of data stored in one or more buffers in the user equipment for transmission and the threshold applied to the amount of data.

The information related to the SDT procedure may alternatively or additionally comprise information relating to a radio environment experienced during the SDT procedure performed by the user equipment. Such information may comprise, for example, one or more of: an indication of a received signal power upon initiating or during the SDT procedure; an indication of a threshold applied by the user equipment to the received signal power to determine whether uplink transmission using the SDT procedure is permitted; an indication of a difference between the received signal power and the threshold applied to the received signal power; and an indication of whether the received signal power was greater than or less than the threshold.

The information related to the SDT procedure may alternatively or additionally comprise information relating to a timing of transmissions during the SDT procedure performed by the user equipment. Such information may comprise, for example, one or more of: an indication of whether a supervision timer expired during the SDT procedure; an indication of a time between arrival of data in one or more buffers for transmission by the user equipment during the SDT procedure and a configured grant of resources for the SDT procedure.

The information related to the SDT procedure may alternatively or additionally comprise information relating to a random-access procedure performed during the SDT procedure performed by the user equipment. Such information may comprise, for example, one or more of: an indication of whether the user equipment was configured with MAC or PHY resources when initiating the random-access procedure; an indication of whether the random-access procedure was triggered upon the user equipment discarding MAC or PHY resources; an indication of a purpose of the random-access procedure; an indication of a number of failed random-access attempts by the user equipment; an indication of whether the random-access procedure was a two-step procedure or a four-step procedure.

The information relating to the SDT procedure may alternatively or additionally comprise information relating to an amount of data transmitted during the SDT procedure. Such information may comprise, for example, one or more of: an indication of the amount of data transmitted during the SDT procedure; an indication of an amount of data remaining to be transmitted at the conclusion of the SDT procedure; and an indication of an amount of data transmitted after an initial transmission during the SDT procedure.

The information relating to the SDT procedure may alternatively or additionally comprise information relating to a geographical location of the user equipment during the SDT procedure.

The information related to the SDT procedure may comprise one or more of: an indication of a power headroom reported by the user equipment for the SDT procedure; an indication of a buffer level reported by the user equipment for the SDT procedure; an indication of a modulation and coding scheme used by the user equipment for the SDT procedure; an indication of a HARQ performance of the user equipment for the SDT procedure; and an indication of whether the user equipment had more SDT data for transmission to the base station upon the base station transmitting a message to the user equipment to change its connection state.

In step 1004, the network node adapts one or more parameters for SDT procedures based on the information contained in the first and/or second reports.

The one or more parameters may comprise one or more of: a length of a supervision timer, expiry of which causes the user equipment to cancel SDT operation; a threshold amount of data for transmission by the user equipment, below which the user equipment is permitted to use SDT operation; a threshold radio signal power, above which the user equipment is permitted to use SDT operation. For example:
The network node knowing the data volume compared to the SDT data volume (e.g., how much the data volume was larger than configured threshold (sdt-DataVolume Threshold)) can optimize its SDT data volume threshold value steering UEs to perform SDT operation.
The network node knowing the RSRP value for some UEs who wanted to perform SDT operation was not above the SDT RSRP threshold (sdt-RSRP-Threshold) may take this information into account for the coverage optimization so the optimized coverage enables the UEs to perform more SDT operations if needed.
The network node knowing whether the UE was configured with the MAC and PHY resources (sdt-MAC-PHY-(G-Config) when initiating the RA procedure may optimize the MAC and PHY resource allocations for the SDT operation i.e., if there are many UEs discarding their MAC and PHY SDT resources the gNB may avoid configuring such resources for the UEs.
The network node knowing the number of failed 2-step RA-SDT attempts before a successful attempt to be able to re-configure the number of 2-step RA-SDT preambles (i.e. change size of the PRACH partition) to reduce the collision rate.

In step 1006, the CU transmits the one or more adapted parameters to a UE and/or a DU. The one or more adapted parameters may be transmitted to the user equipment directly, or as part of a transmission to multiple user equipments (e.g., broadcast as system information, or multicast).

FIG. 11 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3rd Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 11, the hub 1114 communicates with the access network 1104 to facilitate indirect communication between one or more UEs (e.g., UE 1112c and/or 1112d) and network nodes (e.g., network node 1110b ). In some examples, the hub 1114 may be a controller, router, a content source and analytics node, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub-that is, a hub whose primary function is to route communications to/from the UEs from/to the network node 1110b. In other embodiments, the hub 1114 may be a non-dedicated hub-that is, a device which is capable of operating to route communications between the UEs and network node 1110b, but which is additionally capable of operating as a communication start and/or end point for certain data channels.

FIG. 12 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs). The processing circuitry 1202 may be operable to provide, either alone or in conjunction with other UE 1200 components, such as the memory 1210, UE 1200 functionality. For example, the processing circuitry 1202 may be configured to cause the UE 1202 to perform the methods as described with reference to FIG. 8, and/or the signalling and processing of the UE as described with reference to any one of FIGS. 5 and 7.

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In some embodiments, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes processing circuitry 1302, a memory 1304, a communication interface 1306, and a power source 1308, and/or any other component, or any combination thereof. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, network node 1300 functionality. For example, the processing circuitry 1302 may be configured to cause the network node to perform the methods as described with reference to any one of FIGS. 9 and 10, and/or the signalling and processing of the RAN node, RAN node CU and/or RAN node DU as described with reference to any one of FIGS. 5, 6 and 7.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

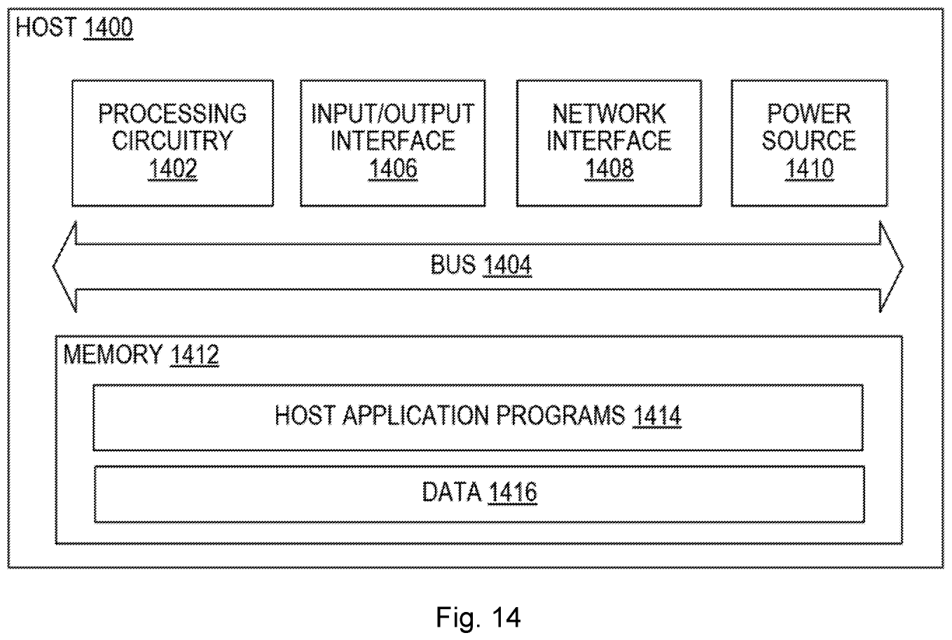

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

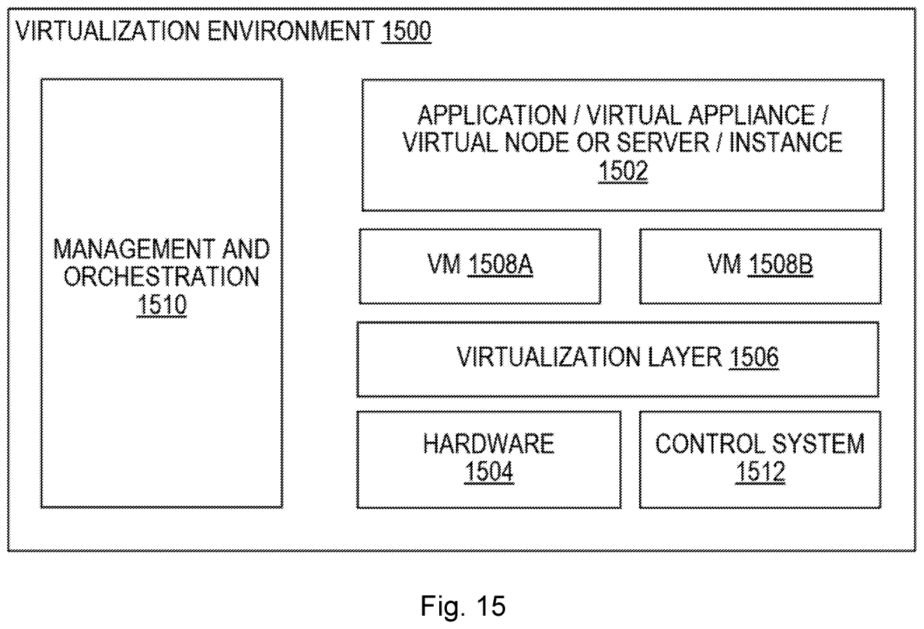

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

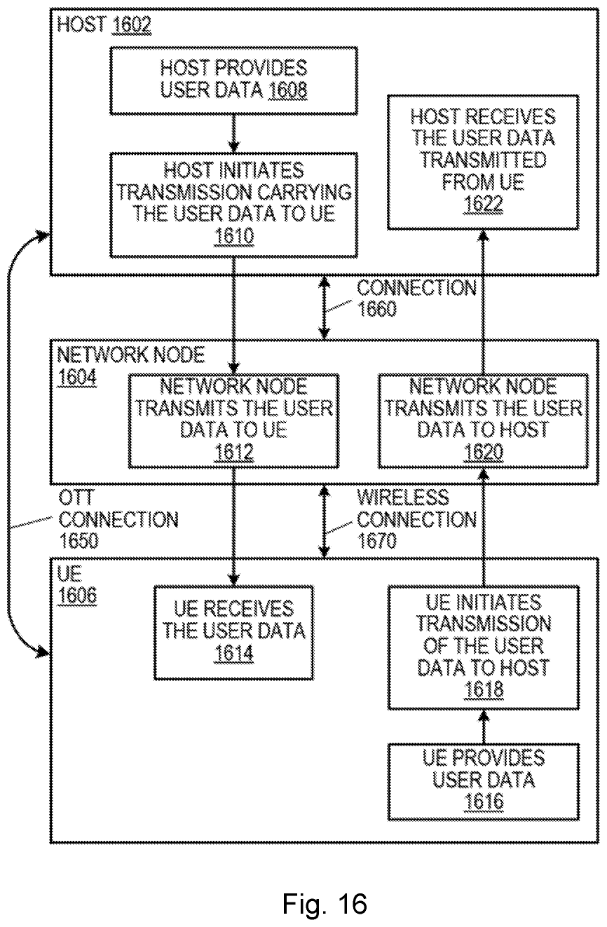

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve the data rate, latency and/or power consumption and thereby provide benefits such as reduced user waiting time, relaxed restrictions on file size, improved content resolution, better responsiveness and/or extended battery lifetime.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

For the avoidance of doubt, the following numbered statements set out embodiments of the disclosure:

### Group A Embodiments

1. A method performed by a user equipment, the method comprising:
   logging information related to a small-data transmissions, SDT, procedure performed by the user equipment in a report; and
   transmitting the report to a network node.
2. The method of embodiment 1, wherein the information related to the SDT procedure is logged responsive to failure of the SDT procedure.
3. The method of embodiment 1, wherein the information related to the SDT procedure is logged responsive to success of the SDT procedure.
4. The method of embodiment 1, wherein the report is transmitted responsive to failure of the SDT procedure.
5. The method of embodiment 1, wherein the report is transmitted responsive to success of the SDT procedure.
6. The method of any one of the preceding embodiments, wherein the report comprises information related to a plurality of SDT procedures performed by the user equipment.
7. The method of any one of embodiments 1 to 5, wherein the report is transmitted to the network node as part of a set of a plurality of reports comprising information related to SDT procedures performed by the user equipment.
8. The method of any one of the preceding embodiments, wherein the SDT procedure comprises an uplink transmission of an amount of data less than a threshold while in an inactive state.
9. The method of embodiment 8, wherein the uplink transmission uses a configured grant of resources.
10. The method of embodiment 8, wherein the uplink transmission follows a random-access procedure performed by the user equipment.
11. The method of any one of the preceding embodiments, further comprising receiving, from the network node, one or more parameters for performance of a further SDT procedure, wherein at least one of the one or more parameters is adapted based on the information related to the SDT procedure performed by the user equipment.
12. The method of any one of the preceding embodiments, wherein the information related to the SDT procedure comprises information relating to an amount of data intended for transmission in the SDT procedure performed by the user equipment.
13. The method of embodiment 12, wherein the information relating to the amount of data comprises one or more of: an indication of the amount of data stored in one or more buffers in the user equipment for transmission; an indication of a threshold applied by the user equipment to the amount of data to determine whether uplink transmission using the SDT procedure is permitted; and an indication of a difference between the amount of data stored in one or more buffers in the user equipment for transmission and the threshold applied to the amount of data.
14. The method of any one of the preceding embodiments, wherein the information related to the SDT procedure comprises information relating to a radio environment experienced during the SDT procedure performed by the user equipment.
15. The method of embodiment 14, wherein the information relating to the radio environment comprises one or more of: an indication of a received signal power upon initiating or during the SDT procedure; an indication of a threshold applied by the user equipment to the received signal power to determine whether uplink transmission using the SDT procedure is permitted; an indication of a difference between the received signal power and the threshold applied to the received signal power; and an indication of whether the received signal power was greater than or less than the threshold.
16. The method of any one of the preceding embodiments, wherein the information related to the SDT procedure comprises information relating to a timing of transmissions during the SDT procedure performed by the user equipment.
17. The method of embodiment 16, wherein the information relating to the timing of transmissions comprises one or more of: an indication of whether a supervision timer expired during the SDT procedure; an indication of a time between arrival of data in one or more buffers for transmission by the user equipment during the SDT procedure and a configured grant of resources for the SDT procedure.
18. The method of any one of the preceding embodiments, wherein the information related to the SDT procedure comprises information relating to a random-access procedure performed during the SDT procedure performed by the user equipment.
19. The method of embodiment 18, wherein the information relating to the random-access procedure comprises one or more of: an indication of whether the user equipment was configured with MAC or PHY resources when initiating the random-access procedure; an indication of whether the random-access procedure was triggered upon the user equipment discarding MAC or PHY resources; an indication of a purpose of the random-access procedure; an indication of a number of failed random-access attempts by the user equipment; an indication of whether the random-access procedure was a two-step procedure or a four-step procedure.
20. The method of any one of the preceding embodiments, wherein the information relating to the SDT procedure comprises information relating to an amount of data transmitted during the SDT procedure.
21. The method of embodiment 20, wherein the information relating to the amount of data transmitted comprises one or more of: an indication of the amount of data transmitted during the SDT procedure; an indication of an amount of data remaining to be transmitted at the conclusion of the SDT procedure; and an indication of an amount of data transmitted after an initial transmission during the SDT procedure.
22. The method of any one of the preceding embodiments, wherein the information relating to the SDT procedure comprises information relating to a geographical location of the user equipment during the SDT procedure.
23. The method of any one of the preceding embodiments, wherein the report comprises one of: a random-access report; and a connection establishment failure report.
24. The method of any of the previous embodiments, further comprising:
   providing user data; and
   forwarding the user data to a host via the transmission to the network node.

### Group B Embodiments

25. A method performed by a distributed unit, DU, of a base station, the method comprising:
   logging information related to a small-data transmissions, SDT, procedure performed by a user equipment towards the DU in a report; and
   transmitting the report to a central unit, CU, of the base station.
26. The method of embodiment 25, wherein the information related to the SDT procedure is logged responsive to commencement of the SDT procedure by the user equipment.
27. The method of embodiment 26, wherein commencement of the SDT procedure by the user equipment comprises reception of a random-access preamble configured for SDT procedures from the user equipment.
28. The method of any one of embodiments 25 to 27, wherein the report comprises information related to a plurality of SDT procedures performed by one or more user equipments.
29. The method of any one of embodiments 25 to 27, wherein the report is transmitted to the CU as part of a set of a plurality of reports comprising information related to SDT procedures performed by one or more user equipments.
30. The method of any one of embodiments 25 to 29, wherein the SDT procedure comprises an uplink transmission by the user equipment of an amount of data less than a threshold while in an inactive state.
31. The method of embodiment 30, wherein the uplink transmission uses a configured grant of resources.
32. The method of embodiment 30, wherein the uplink transmission follows a random-access procedure performed by the user equipment.
33. The method of any one of embodiments 25 to 32, further comprising receiving, from the CU, one or more parameters for performance of a further SDT procedure, wherein at least one of the one or more parameters is adapted based on the information related to the SDT procedure performed by the user equipment.
34. The method of any one of embodiments 25 to 33, wherein the information related to the SDT procedure comprises one or more of: an indication of a power headroom reported by the user equipment for the SDT procedure; an indication of a buffer level reported by the user equipment for the SDT procedure; an indication of a modulation and coding scheme used by the user equipment for the SDT procedure; an indication of a HARQ performance of the user equipment for the SDT procedure; and an indication of whether the user equipment had more SDT data for transmission to the base station upon the base station transmitting a message to the user equipment to change its connection state.
35. A method performed by a network node, the method comprising:
   receiving one or more reports comprising information relating to one or more small data transmission, SDT, procedures, the one or more reports comprising one or more of:
      a first report received from a user equipment and comprising information relating to one or more SDT procedures performed by the user equipment; and
      a second report received from a distributed unit coupled to the network node and comprising information relating to one or more SDT procedures performed by the distributed unit; and
   adapting one or more parameters for SDT procedures based on the information.
36. The method of embodiment 35, further comprising transmitting the one or more adapted parameters to the user equipment.
37. The method of embodiment 36, wherein the one or more adapted parameters are transmitted to the user equipment as part of a transmission to multiple user equipments.
38. The method of any one of embodiments 35 to 37, wherein the SDT procedure comprises an uplink transmission of an amount of data less than a threshold while in an inactive state.
39. The method of embodiment 38, wherein the uplink transmission uses a configured grant of resources.
40. The method of embodiment 38, wherein the uplink transmission follows a random-access procedure performed by the user equipment.
41. The method of any one of embodiments 35 to 40, wherein the information related to the SDT procedure comprises information relating to an amount of data intended for transmission in the SDT procedure performed by the user equipment.
42. The method of embodiment 41, wherein the information relating to the amount of data comprises one or more of: an indication of the amount of data stored in one or more buffers in the user equipment for transmission; an indication of a threshold applied by the user equipment to the amount of data to determine whether uplink transmission using the SDT procedure is permitted; and an indication of a difference between the amount of data stored in one or more buffers in the user equipment for transmission and the threshold applied to the amount of data.
43. The method of any one of embodiments 35 to 42, wherein the information related to the SDT procedure comprises information relating to a radio environment experienced during the SDT procedure performed by the user equipment.
44. The method of embodiment 43, wherein the information relating to the radio environment comprises one or more of: an indication of a received signal power upon initiating or during the SDT procedure; an indication of a threshold applied by the user equipment to the received signal power to determine whether uplink transmission using the SDT procedure is permitted; an indication of a difference between the received signal power and the threshold applied to the received signal power; and an indication of whether the received signal power was greater than or less than the threshold.
45. The method of any one of embodiments 35 to 44, wherein the information related to the SDT procedure comprises information relating to a timing of transmissions during the SDT procedure performed by the user equipment.
46. The method of embodiment 45, wherein the information relating to the timing of transmissions comprises one or more of: an indication of whether a supervision timer expired during the SDT procedure; an indication of a time between arrival of data in one or more buffers for transmission by the user equipment during the SDT procedure and a configured grant of resources for the SDT procedure.
47 The method of any one of embodiments 35 to 46, wherein the information related to the SDT procedure comprises information relating to a random-access procedure performed during the SDT procedure performed by the user equipment.
48. The method of embodiment 47, wherein the information relating to the random-access procedure comprises one or more of: an indication of whether the user equipment was configured with MAC or PHY resources when initiating the random-access procedure; an indication of whether the random-access procedure was triggered upon the user equipment discarding MAC or PHY resources; an indication of a purpose of the random-access procedure; an indication of a number of failed random-access attempts by the user equipment; an indication of whether the random-access procedure was a two-step procedure or a four-step procedure.
49. The method of any one of embodiments 35 to 48, wherein the information relating to the SDT procedure comprises information relating to an amount of data transmitted during the SDT procedure.
50. The method of embodiment 49, wherein the information relating to the amount of data transmitted comprises one or more of: an indication of the amount of data transmitted during the SDT procedure; an indication of an amount of data remaining to be transmitted at the conclusion of the SDT procedure; and an indication of an amount of data transmitted after an initial transmission during the SDT procedure.
51. The method of any one of embodiments 35 to 50, wherein the information relating to the SDT procedure comprises information relating to a geographical location of the user equipment during the SDT procedure.
52. The method of any one of embodiments 35 to 51, wherein the information related to the SDT procedure comprises one or more of: an indication of a power headroom reported by the user equipment for the SDT procedure; an indication of a buffer level reported by the user equipment for the SDT procedure; an indication of a modulation and coding scheme used by the user equipment for the SDT procedure; an indication of a HARQ performance of the user equipment for the SDT procedure; and an indication of whether the user equipment had more SDT data for transmission to the base station upon the base station transmitting a message to the user equipment to change its connection state.
53. The method of any one of embodiments 35 to 52, wherein the report comprises one of: a random-access report; and a connection establishment failure report.
54. The method of any one of embodiments 35 to 53, wherein the one or more parameters comprise one or more of: a length of a supervision timer, expiry of which causes the user equipment to cancel SDT operation; a threshold amount of data for transmission by the user equipment, below which the user equipment is permitted to use SDT operation; a threshold radio signal power, above which the user equipment is permitted to use SDT operation.
55. The method of any one of embodiments 35 to 54, wherein the network node is a central unit of the base station.
56. The method of any one of embodiments 35 to 54, wherein the network node is a base station.
57. The method of any of the previous embodiments, further comprising:
   obtaining user data; and
   forwarding the user data to a host or a user equipment.

### Group C Embodiments

58. A user equipment, comprising:
   processing circuitry configured to cause the user equipment to perform any of the steps of any of the Group A embodiments; and
   power supply circuitry configured to supply power to the processing circuitry.
59. A network node, the network node comprising:
   processing circuitry configured to cause the network node to perform any of the steps of any of the Group B embodiments;
   power supply circuitry configured to supply power to the processing circuitry.
60. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and a battery connected to the processing circuitry and configured to supply power to the UE.
61. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
62. The host of the previous embodiment, wherein the cellular network further includes a network node configured to communicate with the UE to transmit the user data to the UE from the host.
63. The host of the previous 2 embodiments, wherein:
   the processing circuitry of the host is configured to execute a host application, thereby providing the user data; and
   the host application is configured to interact with a client application executing on the UE, the client application being associated with the host application.
64. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
65. The method of the previous embodiment, further comprising:
   at the host, executing a host application associated with a client application executing on the UE to receive the user data from the UE.
66. The method of the previous embodiment, further comprising:
   at the host, transmitting input data to the client application executing on the UE, the input data being provided by executing the host application,
   wherein the user data is provided by the client application in response to the input data from the host application.
67. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
68. The host of the previous embodiment, wherein the cellular network further includes a network node configured to communicate with the UE to transmit the user data from the UE to the host.
69. The host of the previous 2 embodiments, wherein:
   the processing circuitry of the host is configured to execute a host application, thereby providing the user data; and
   the host application is configured to interact with a client application executing on the UE, the client application being associated with the host application.
70. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
71. The method of the previous embodiment, further comprising:
   at the host, executing a host application associated with a client application executing on the UE to receive the user data from the UE.
72. The method of the previous embodiment, further comprising:
   at the host, transmitting input data to the client application executing on the UE, the input data being provided by executing the host application,
   wherein the user data is provided by the client application in response to the input data from the host application.
73. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
74. The host of the previous embodiment, wherein:
   the processing circuitry of the host is configured to execute a host application that provides the user data; and
   the UE comprises processing circuitry configured to execute a client application associated with the host application to receive the transmission of user data from the host.
75. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
76. The method of the previous embodiment, further comprising, at the network node, transmitting the user data provided by the host for the UE.
77. The method of any of the previous 2 embodiments, wherein the user data is provided at the host by executing a host application that interacts with a client application executing on the UE, the client application being associated with the host application.
78. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
79. The communication system of the previous embodiment, further comprising:
   the network node; and/or
   the user equipment.
80. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
81. The host of the previous embodiment, wherein:
   the processing circuitry of the host is configured to execute a host application, thereby providing the user data; and
   the host application is configured to interact with a client application executing on the UE, the client application being associated with the host application.
82. The host of the any of the previous 2 embodiments, wherein the initiating receipt of the user data comprises requesting the user data.
83. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
84. The method of the previous embodiment, further comprising at the network node, transmitting the received user data to the host.

1-41. (canceled)

42. A method performed by a user equipment, the method comprising:
logging information related to a small-data transmissions (SDT) procedure performed by the user equipment in a report; and
transmitting the report to a network node.

43. The method of claim 42, wherein the information related to the SDT procedure is logged responsive to failure or success of the SDT procedure.

44. The method of claim 42, further comprising receiving, from the network node, one or more parameters for performing a further SDT procedure, wherein at least one of the one or more parameters is adapted based on the information related to the SDT procedure performed by the user equipment.

45. The method of claim 42, wherein the information related to the SDT procedure comprises information relating to a random-access procedure performed during the SDT procedure performed by the user equipment.

46. The method of claim 42, wherein the information relating to the SDT procedure comprises information relating to a geographical location of the user equipment during the SDT procedure.

47. The method of claim 42, wherein the report comprises one of: a random-access report;
and a connection establishment failure report.

48. A method performed by a distributed unit (DU) of a base station, the method comprising:
logging information related to a small-data transmissions (SDT) procedure performed by a user equipment towards the DU in a report; and
transmitting the report to a central unit (CU) of the base station.

49. The method of claim 48, wherein the report is transmitted to the CU as part of a set of a plurality of reports comprising information related to SDT procedures performed by one or more user equipments.

50. The method of claim 48, further comprising receiving, from the CU, one or more parameters for performing a further SDT procedure, wherein at least one of the one or more parameters is adapted based on the information related to the SDT procedure performed by the user equipment.

51. A method performed by a network node, the method comprising:
receiving one or more reports comprising information relating to one or more small data transmission (SDT) procedures, the one or more reports comprising one or more of:
a first report received from a user equipment and comprising information relating to one or more SDT procedures performed by the user equipment; and
a second report received from a distributed unit coupled to the network node and comprising information relating to one or more SDT procedures performed by the distributed unit; and
adapting one or more parameters for SDT procedures based on the information.

52. The method of claim 51, wherein the information relating to the SDT procedure comprises information relating to a geographical location of the user equipment during the SDT procedure.

53. The method of claim 51, wherein the report comprises one of: a random-access report;
and a connection establishment failure report.

54. A user equipment, comprising:
communication interface circuitry configured to communicate with a wireless network; and
processing circuitry configured to cause the user equipment to perform a method according to claim 42.

55. A distributed unit for a base station, the distributed unit comprising:
communication interface circuitry configured to communicate with one or more user equipments (UEs); and
processing circuitry configured to cause the distributed unit to perform a method according to claim 48.

56. A network node comprising:
communication interface circuitry configured to communicate with one or more user equipments (UEs); and
processing circuitry configured to cause the network node to perform the method according to claim 51.
